(19) United States
(12) Patent Application Publication
(10) Pub. No.: US 2011/0102363 A1
(43) Pub. Date: May 5, 2011

(54) TOUCH PANEL

(75) Inventors: Tun-Chun Yang, Taipei City (TW); Yu-Feng Chien, Taipei County (TW); Seok-Lyul Lee, Hsinchu City (TW); Wei-Ming Huang, Taipei City (TW)

(73) Assignee: AU OPTRONICS CORPORATION, Hsinchu (TW)

(21) Appl. No.: 12/719,018

(22) Filed: Mar. 8, 2010

(30) Foreign Application Priority Data
Nov. 2, 2009 (TW) 98137153

(51) Int. Cl. G06F 3/045; G06F 3/041; G06F 3/042

(52) U.S. Cl. 345/174; 345/173; 345/176

(57) ABSTRACT

A touch panel including a substrate, a plurality of first touch electrode series, and a plurality of second touch electrode series is provided. The first touch electrode series are disposed on the substrate and extend along a first direction. Each first touch electrode series has a plurality of first touch pads electrically connected to each others. The second touch electrode series are disposed on the substrate and extend along a second direction. Each second touch electrode series has a plurality of second touch pads electrically connected to each others. The first direction is different from the second direction. Moreover, a distance between the adjacent first sensing pad and second sensing pad is about 10˜60 micron.

### CROSS-REFERENCE TO RELATED APPLICATION

This application claims the priority benefit of Taiwan application serial no. 98137153, filed on Nov. 2, 2009. The entirety of the above-mentioned patent application is hereby incorporated by reference herein and made a part of specification.

### BACKGROUND OF THE INVENTION

1. Field of the Invention

The present invention is related to a touch panel, and particularly to a touch panel with a better visual perception.

2. Description of Related Art

According to different principles, the touch panels can be categorized into resistance touch panels, capacitance touch panels, optical touch panels, sound wave touch panels, and electromagnetic touch panels. Since the capacitance touch panels possess the features of fast response time, high sensitivity, high reliability, and long durability, the capacitance touch panels are now widely used.

According to the assembly methods, the capacitance touch panels can be classified into external-bond capacitance touch panel and integrative (built in) capacitance touch panel. The manufacturing procedure of the integrative capacitance touch panel is simple and the touch electrode pattern of the integrative capacitance touch panel is easy to be designed. However, the touch electrode series of the external-bond capacitance touch panel or the integrative capacitance touch panel is made of transparent conductive oxide with the transmittance and the refractive index different from those of the substrate. Therefore, the profile of the touch electrode series can be easily perceived by the user. Hence, the visual perception is worse. Moreover, it is possible that the profile of the electrode pattern is so obvious that the display quality of the touch displaying panel is decreased.

### SUMMARY OF THE INVENTION

The invention provides a touch panel with the gap design between the touch pads or the gap design between the touch pad and the insulating pad so that it is not easy for the user to perceive the touch electrode series.

The invention provides another touch panel with the thickness design of the touch pad so that it is not easy for the user to perceive the touch electrode series.

The present invention provides a touch panel including a substrate, first touch electrode series and second touch electrode series. The first touch electrode series are disposed on the substrate and extend along a first direction, wherein each of the first touch electrode series comprises a plurality of first touch pads electrically connected to each other. The second touch electrode series are disposed on the substrate and extend along a second direction, wherein each of the second touch electrode series comprises a plurality of second touch pads electrically connected to each other. The first direction is different from the second direction, and a distance between the adjacent first touch pad and second touch pad is about 10˜60 micron. According to one embodiment of the invention, a thickness of each of the first touch pads and the second touch pads is about 300˜600 angstrom.

The present invention further provides a touch panel including a substrate, first touch electrode series and second touch electrode series. The first touch electrode series are disposed on the substrate and extend along a first direction, wherein each of the first touch electrode series comprises a plurality of first touch pads electrically connected to each other. The second touch electrode series are disposed on the substrate and extend along a second direction, wherein each of the second touch electrode series comprises a plurality of second touch pads electrically connected to each other. The first direction is different from the second direction, and a thickness of each of the first touch pads and the second touch pads is about 300˜600 angstrom.

The present invention provides a touch panel including a substrate, first touch electrode series, second touch electrode series and insulating pads. The first touch electrode series are disposed on the substrate and extend along a first direction, wherein each of the first touch electrode series comprises a plurality of first touch pads electrically connected to each other. The second touch electrode series are disposed on the substrate and extend along a second direction, wherein each of the second touch electrode series comprises a plurality of second touch pads electrically connected to each other, and the first direction is different from the second direction. The insulating pads are respectively disposed between the first touch pads and the adjacent second touch pads, and a distance between each of the insulating pads and each of the first touch pads is about 10˜60 micrometers and a distance between each of the insulating pads and each of the second touch pads is about 10˜60 micrometers. In a preferred embodiment of the present invention, a thickness of each of the first touch pads and the second touch pads is about 300˜600 angstrom.

According to one embodiment of the present invention, the substrate comprises a first surface and a second surface opposite to the first surface.

According to one embodiment of the present invention, the first touch electrode series and the second touch electrode series are disposed on the first surface of the substrate.

According to one embodiment of the present invention, the touch panel further includes a dielectric layer disposed on the first surface of the substrate to cover the first touch electrode series and the second touch electrode series.

According to one embodiment of the present invention, the touch panel further includes a dielectric layer and a transparent electrode. Also, the dielectric layer is disposed on the first surface of the substrate to cover the first touch electrode series and the second touch electrode series. Moreover, the transparent electrode is disposed on the second surface.

According to one embodiment of the present invention, the touch panel further includes a transparent electrode on the second surface of the substrate.

According to one embodiment of the present invention, the touch panel further includes a transparent electrode and an inter-layer dielectric layer. The transparent electrode is disposed on the first surface of the substrate. The inter-layer dielectric layer is disposed on the transparent electrode, wherein the first touch electrode series and the second touch electrode series are disposed on the inter-layer dielectric layer.

According to the above description, in the present invention, by controlling the thickness of the touch pad or the distance between the touch pads, it is not easy for the user to perceive the profile of the touch pad while using the touch panel.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a touch panel according to one embodiment of the present invention.

FIG. 1B is a schematic cross-sectional view along a line I-I′ in FIG. 1A.

FIG. 2 is a cross-sectional view of a touch panel according to another embodiment of the present invention.

FIG. 3 is a cross-sectional view of a touch panel according to still another embodiment of the present invention.

FIG. 4 is a cross-sectional view of a touch panel according to still another embodiment of the present invention.

FIG. 5 is a cross-sectional view of a touch panel according to still another embodiment of the present invention.

FIG. 6A is a schematic top view of a touch panel according to one embodiment of the present invention.

FIG. 6B is a schematic cross-sectional view along a line II-II′ in FIG. 6A.

FIG. 7 is a cross-sectional view of a touch panel according to another embodiment of the present invention.

FIG. 8 is a cross-sectional view of a touch panel according to still another embodiment of the present invention.

FIG. 9 is a cross-sectional view of a touch panel according to still another embodiment of the present invention.

FIG. 10 is a cross-sectional view of a touch panel according to still another embodiment of the present invention.

### DESCRIPTION OF EMBODIMENTS

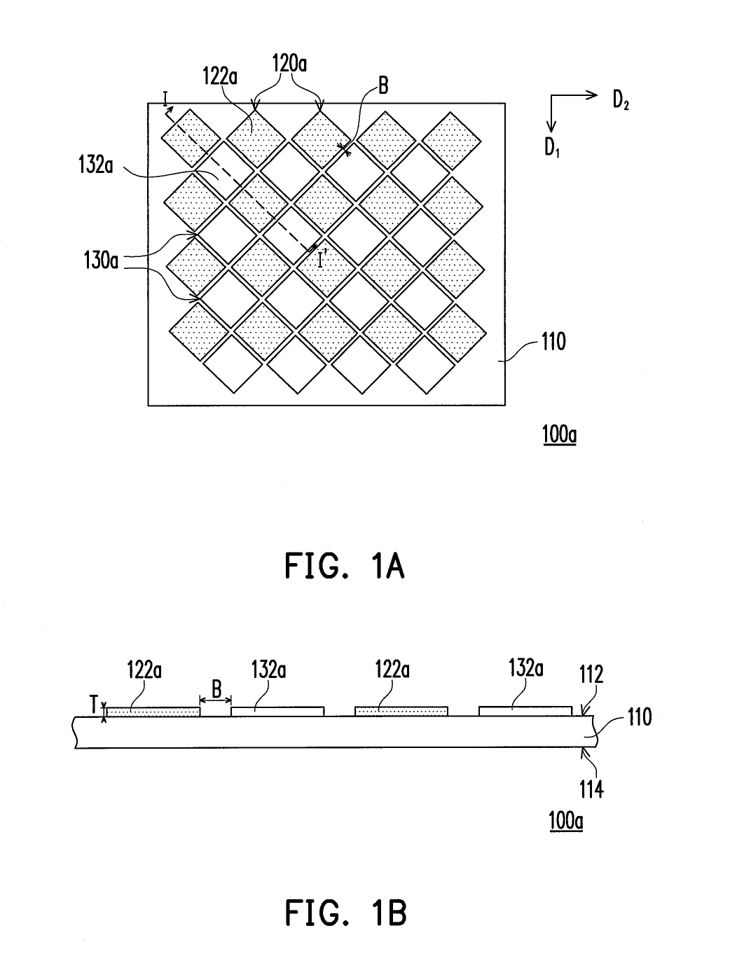

FIG. 1A is a schematic top view of a touch panel according to one embodiment of the present invention. FIG. 1B is a schematic cross-sectional view along a line I-I′ in FIG. 1A. As shown in FIG. 1A together with FIG. 1B, a touch panel 100a comprises a substrate 110, a plurality of first touch electrode series 120a and a plurality of second touch electrode series 130a. The substrate 110 of the present embodiment comprises a first surface 112 and a second surface 114 opposite to the first surface 112. Furthermore, the first touch electrode series 120a are disposed on the substrate 110 and extend along a first direction D₁. Each of the first touch electrode series 120a comprises a plurality of first touch pads 122a electrically connected to each other. The second touch electrode series 130a are disposed on the substrate 110 and extend along a second direction D₂. Each of the second touch electrode series 130a comprises a plurality of second touch pads 132a electrically connected to each other, and the first direction D₁ is different from the second direction D₂. In the present embodiment, the first touch electrode series 120a and the second touch electrode series 130a are disposed on the first surface 112. In the present embodiment, the first touch pads 122a and the second touch pads 132a can be, for example, made from a transparent conductive layer. The transparent conductive layer can be, for example, made of indium tin oxide (ITO) or indium zinc oxide (IZO).

It should be noticed that a distance B between the first touch pad 122a and the second touch pad 132a adjacent to the first touch pad 122a is about 1˜100 micron. The smaller the distance between the first touch pad 122a and the second touch pad 132a adjacent to the first touch pad 122a is, the more difficult the user can perceive the first touch pads 122a and the second touch pads 132a. Furthermore, in one embodiment, the distance B between the first touch pad 122a and the second touch pad 132a adjacent to the first touch pad 122a is about 10˜60 micron.

Besides the distance B between the first touch pad 122a and the second touch pad 132a adjacent to the first touch pad 122a, the thickness T of each of the first touch pads 122a and the second touch pads 132a also can affect the visual perception of the user. In another embodiment of the present invention, the thickness T of each of the first touch pads 122a and the second touch pads 132a is about 100˜10000 angstrom. More particularly, the thickness T of each of the first touch pads 122a and the second touch pads 132a is about 300˜600 angstrom.

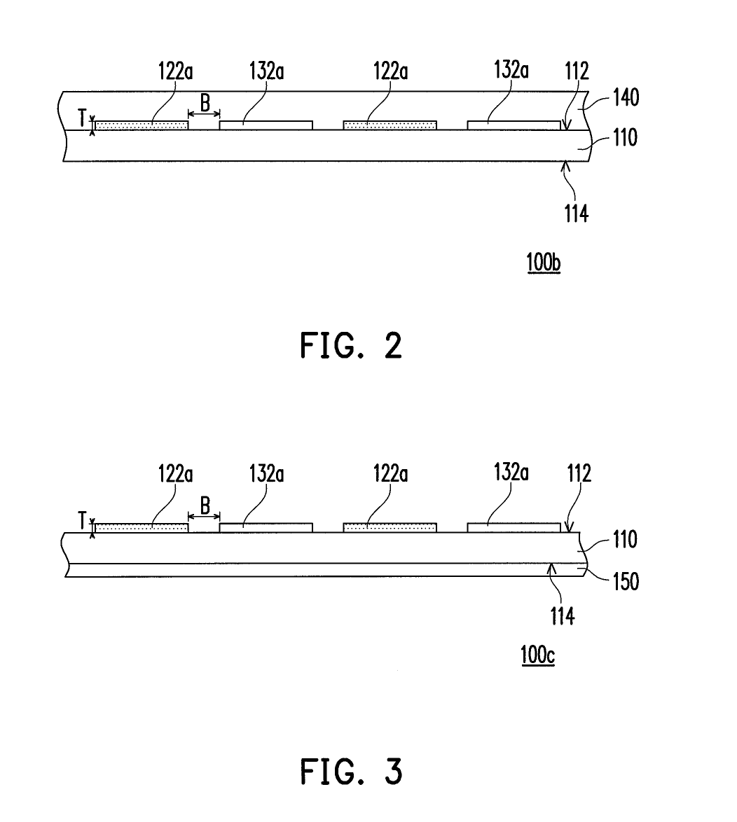

In the present embodiment, the designer can solve the problem of excessively obvious profile of the touch pads by choosing a particular distance B or a particular thickness T so that the user may not easily perceive the profile of the touch pads. In practical design, the first touch pads 122a and the second touch pads 132a of the present invention are not limited to satisfy both conditions of distance B and thickness T. In other words, the designs of the first touch pads 122a and the second touch pads 132a only need to satisfy one of the conditions of distance B and thickness T to overcome the problem of excessively obvious profile of the touch pads. Hereafter, various embodiments of the present invention will be described in detail below with reference to FIGS. 2 through 5.

FIG. 2 is a cross-sectional view of a touch panel according to another embodiment of the present invention. As shown in FIG. 2, the touch panel 100b of the present embodiment is similar to the touch panel 100a of the previous embodiment in structure. However, the touch panel 100b of the present embodiment further comprises a dielectric layer 140 disposed on the first surface 112 of the substrate 110 to cover the first touch electrode series 120a and the second touch electrode series 130a.

FIG. 3 is a cross-sectional view of a touch panel according to still another embodiment of the present invention. As shown in FIG. 3, the touch panel 100c of the present embodiment is similar to the touch panel 100a of the previous embodiment in structure. However, the touch panel 100c of the present embodiment further comprises a transparent electrode 150 disposed on the second surface 114 of the substrate 110.

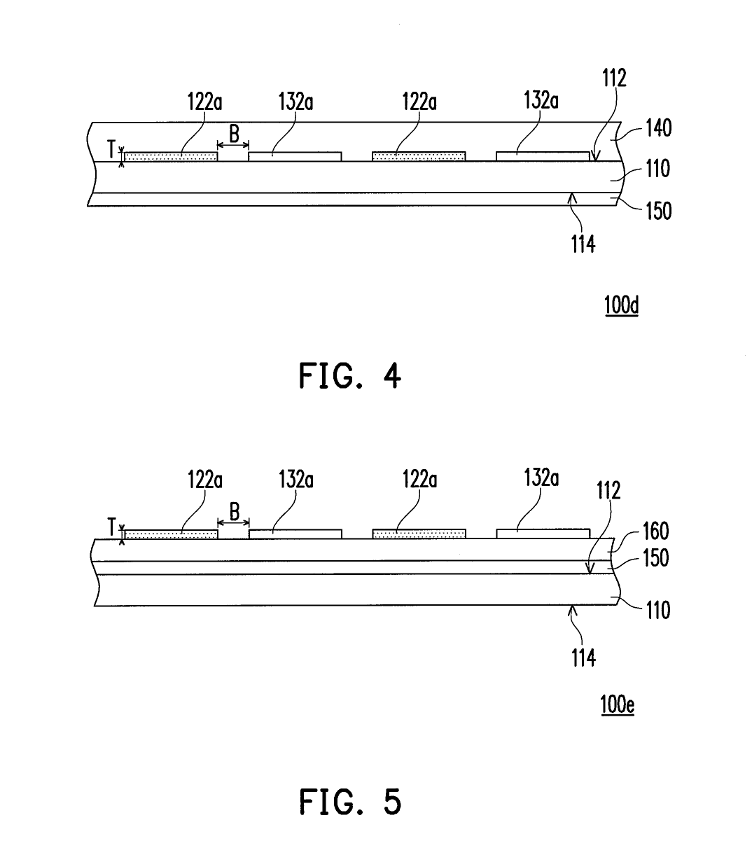

FIG. 4 is a cross-sectional view of a touch panel according to still another embodiment of the present invention. As shown in FIG. 4, the touch panel 100d of the present embodiment is similar to the touch panel 100b of the previous embodiment in structure. However the touch panel 100d of the present embodiment further comprises a transparent electrode 150 disposed on the second surface 114 of the substrate 110.

FIG. 5 is a cross-sectional view of a touch panel according to still another embodiment of the present invention. As shown in FIG. 5, the touch panel 100e of the present embodiment is similar to the touch panel 100a of the previous embodiment in structure. However, the touch panel 100e of the present embodiment further comprises a transparent electrode 150 and an inter-layer dielectric layer 160. Furthermore, the transparent electrode 150c is disposed on the first surface 112 of the substrate 110. The inter-layer dielectric layer 160 is disposed on the transparent electrode 150, wherein the first touch electrode series 120a and the second touch electrode series 130a are disposed on the inter-layer dielectric layer 160.

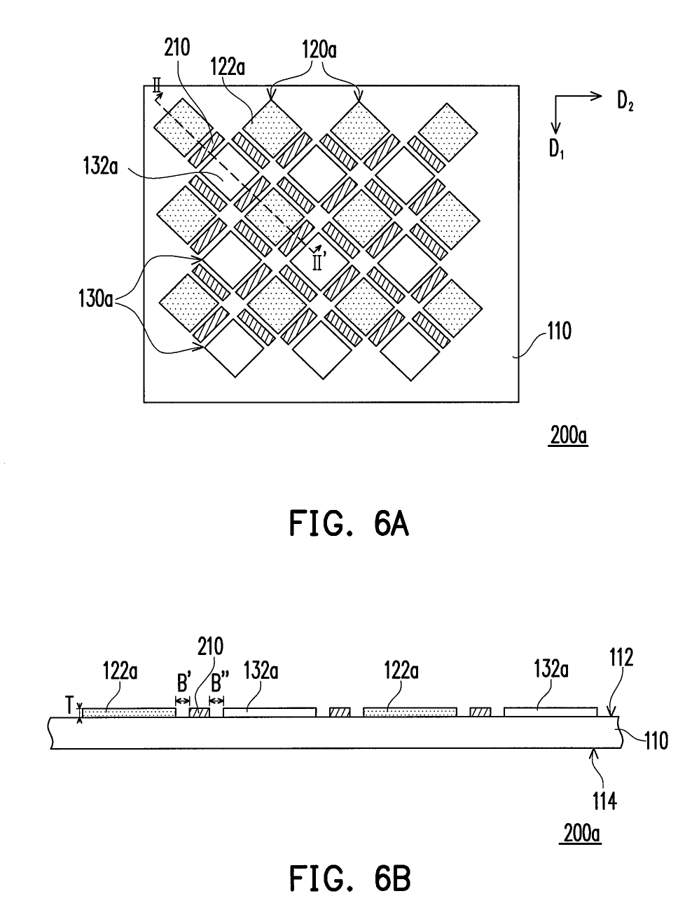

FIG. 6A is a schematic top view of a touch panel according to one embodiment of the present invention, and FIG. 6B is a schematic cross-sectional view along a line II-II′ in FIG. 6A. As shown in FIG. 1A, FIG. 1B, FIG. 6A and FIG. 6B, the touch panel 200a of the present embodiment is similar to the aforementioned touch panel 100a in structure. However, the touch panel 200a further comprises a plurality of insulating pads 210. In the present embodiment, the insulating pads 210 are disposed between each of the first touch pads 122a and each of the second touch pads 132a respectively (as shown in FIG. 6A and FIG. 6B). In the present embodiment, the insulating pads 210 can be, for example, made from a transparent conductive layer. The transparent conductive layer can be, for example, made of indium tin oxide (ITO) or indium zinc oxide (IZO).

More clearly, the distance B′ between the insulating pad 210 and the first touch pad 122a adjacent to the insulating pad 210 is about 10˜60 micron, and the distance B″ between the insulating pad 210 and the second touch pad 132a adjacent to the insulating pad 210 is about 10˜60 micron (as shown in FIG. 6B).

It should be noticed that, when the distance B′ between the insulating pad 210 and the adjacent first touch pad 122a and the distance B″ between the insulating pad 210 and the adjacent second touch pad 132a are appropriately adjusted, the display quality of the display panel with the use of the touch panel 200a can be improved. Moreover, the thickness and the transmittance of the insulating pad 210 are closely related to the display quality of the touch panel 200a and can be appropriately adjusted by user demands, which is not described herein.

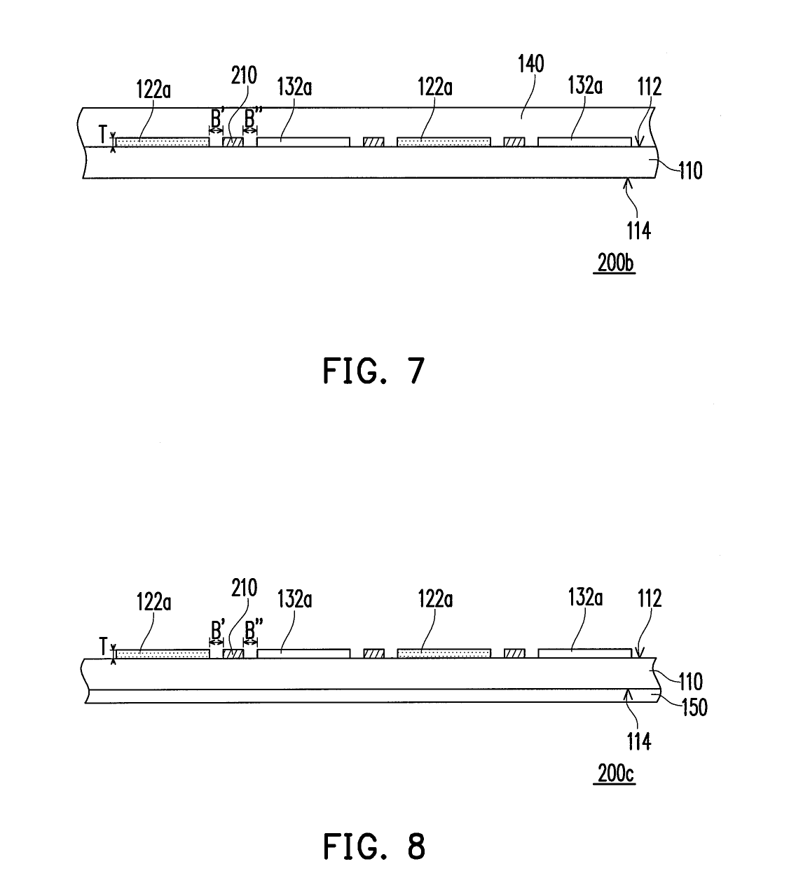

Similarly, various embodiments of the present invention will be described in detail below with reference to FIGS. 7 through 10.

FIG. 7 is a cross-sectional view of a touch panel according to another embodiment of the present invention. As shown in FIG. 6B and FIG. 7, the touch panel 200b of the present embodiment is similar to the touch panel 200a of the previous embodiment in structure. However, the touch panel 200b of the present embodiment further comprises a dielectric layer 140 disposed on the first surface 112 of the substrate 110 to cover the first touch electrode series 120a, the second touch electrode series 130a and the insulating pads 210.

FIG. 8 is a cross-sectional view of a touch panel according to still another embodiment of the present invention. As shown in FIG. 6B and FIG. 8, the touch panel 200c of the present embodiment is similar to the touch panel 200a of the previous embodiment in structure. However, the touch panel 200c of the present embodiment further comprises a transparent electrode 150 disposed on the second surface 114 of the substrate 110.

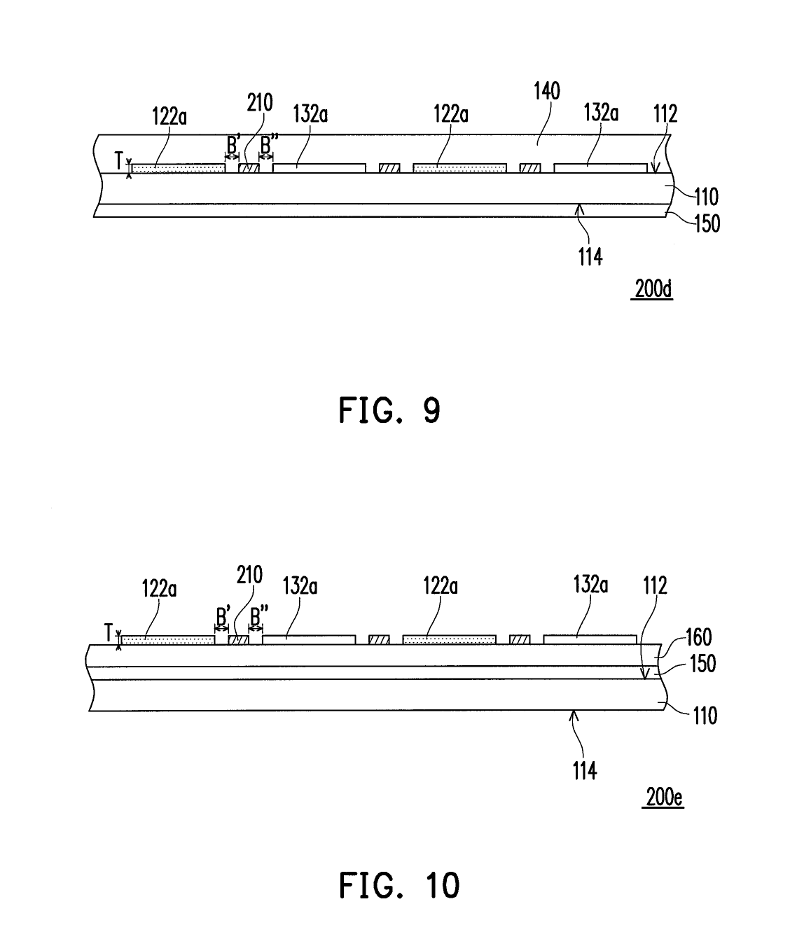

FIG. 9 is a cross-sectional view of a touch panel according to still another embodiment of the present invention. As shown in FIG. 7 and FIG. 9, the touch panel 200d of the present embodiment is similar to the touch panel 200b of the previous embodiment in structure. However, the touch panel 200d of the present embodiment further comprises a transparent electrode 150 disposed on the second surface 114 of the substrate 110.

FIG. 10 is a cross-sectional view of a touch panel according to still another embodiment of the present invention. As shown in FIG. 6B and FIG. 10, the touch panel 200e of the present embodiment is similar to the touch panel 200a of the previous embodiment in structure. However, the touch panel 200e of the present embodiment further comprises a transparent electrode 150 and an inter-layer dielectric layer 160. Furthermore, the transparent electrode 150 is disposed on the first surface 112 of the substrate 110. The inter-layer dielectric layer 160 is disposed on the transparent electrode 150, wherein the first touch electrode series 120a, the second touch electrode series 130a and the insulating pads 210 are disposed on the inter-layer dielectric layer 160.

According to the above description, in the present invention, by controlling the distance between the touch pads or the distance between the touch pad and the insulating pad within a particular range or by controlling the thickness of the touch pad, the problem of excessively obvious profile of the touch pad can be overcome and it is not easy for the user to perceive the shapes of the touch pads. Moreover, in some of the embodiments, the aforementioned methods of controlling the distance between the touch pads and between the touch pad and the insulating pad and controlling the thickness of the touch pad can be both applied to decrease the probability of the touch pads being perceived by the users. Consequently, the touch panel of the present invention can provide the users a better visual perception.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch panel, comprising:
a substrate;
a plurality of first touch electrode series disposed on the substrate and extending along a first direction, wherein each of the first touch electrode series comprises a plurality of first touch pads electrically connected to each other; and
a plurality of second touch electrode series disposed on the substrate and extending along a second direction, wherein each of the second touch electrode series comprises a plurality of second touch pads electrically connected to each other, and the first direction is different from the second direction, and a distance between the adjacent first touch pad and second touch pad is about 10˜60 micron.

2. The touch panel of claim 1, wherein the substrate has a first surface and a second surface opposite to the first surface.

3. The touch panel of claim 2, wherein the first touch electrode series and the second touch electrode series are disposed on the first surface.

4. The touch panel of claim 3, further comprising a dielectric layer disposed on the first surface of the substrate to cover the first touch electrode series and the second touch electrode series.

5. The touch panel of claim 3, further comprising:
a dielectric layer disposed on the first surface to cover the first touch electrode series and the second touch electrode series; and
a transparent electrode disposed on the second surface.

6. The touch panel of claim 3, further comprising a transparent electrode disposed on the second surface.

7. The touch panel of claim 2, further comprising:
a transparent electrode disposed on the first surface; and
an inter-layer dielectric layer disposed on the transparent electrode, wherein the first touch electrode series and the second touch electrode series are disposed on the inter-layer dielectric layer.

8. The touch panel of claim 1, wherein a thickness of each of the first touch pads and the second touch pads is about 300˜600 angstrom.

9. A touch panel, comprising:
a substrate;
a plurality of first touch electrode series disposed on the substrate and extending along a first direction, wherein each of the first touch electrode series comprises a plurality of first touch pads electrically connected to each other;
a plurality of second touch electrode series disposed on the substrate and extending along a second direction, wherein each of the second touch electrode series comprises a plurality of second touch pads electrically connected to each other, and the first direction is different from the second direction; and
a plurality of insulating pads disposed between each of the first touch pads and each of the second touch pads respectively, wherein a distance between each of the insulating pads and each of the first touch pads is about 10˜60 micron, and a distance between each of the insulating pads and each of the second touch pads is about 10˜60 micron.

10. The touch panel of claim 9, wherein the substrate has a first surface and a second surface opposite to the first surface.

11. The touch panel of claim 10, wherein the first touch electrode series, the second touch electrode series and the insulating pads are disposed on the first surface.

12. The touch panel of claim 11, further comprising a dielectric layer disposed on the first surface of the substrate to cover the first touch electrode series, the second touch electrode series and the insulating pads.

13. The touch panel of claim 11, further comprising:
a dielectric layer disposed on the first surface to cover the first touch electrode series, the second touch electrode series and the insulating pads; and
a transparent electrode disposed on the second surface.

14. The touch panel of claim 11, further comprising a transparent electrode disposed on the second surface.

15. The touch panel of claim 10, further comprising:
a transparent electrode disposed on the first surface; and
an inter-layer dielectric layer disposed on the transparent electrode, wherein the first touch electrode series, the second touch electrode series and the insulating pads are disposed on the inter-layer dielectric layer.

16. The touch panel of claim 9, wherein a thickness of each of the first touch pads and the second touch pads is about 300˜600 angstrom.

17. A touch panel, comprising:
a substrate;
a plurality of first touch electrode series, disposed on the substrate and extending along a first direction, wherein each of the first touch electrode series comprises a plurality of first touch pads electrically connected to each other; and
a plurality of second touch electrode series, disposed on the substrate and extending along a second direction being different from the first direction, wherein each of the second touch electrode series comprises a plurality of second touch pads electrically connected to each other, and a thickness of each of the first touch pads and the second touch pads is about 300˜600 angstrom.

18. The touch sensing panel of claim 17, wherein the substrate has a first surface and a second surface opposite to the first surface.

19. The touch sensing panel of claim 18, further comprising:
a dielectric layer disposed on the first surface to cover the first touch electrode series and the second touch electrode series; and
a transparent electrode disposed on the second surface.

20. The touch panel of claim 18, further comprising:
a transparent electrode disposed on the first surface; and
an inter-layer dielectric layer disposed on the transparent electrode, wherein the first touch electrode series and the second touch electrode series are disposed on the inter-layer dielectric layer.
